(19) United States
(12) Patent Application Publication
(10) Pub. No.: US 2015/0262431 A1
(43) Pub. Date: Sep. 17, 2015

(54) PARKING METER PAYMENT DEVICE

(71) Applicant: Clear Token Inc., Denver, CO (US)

(72) Inventors: Lawrence Berman, Delray Beach, FL (US); Stanley J. Wolfson, Denver, CO (US); Grant J. Holland, Englewood, CO (US)

(21) Appl. No.: 14/671,456

(22) Filed: Mar. 27, 2015

Related U.S. Application Data
(63) Continuation-in-part of application No. 14/645,196, filed on Mar. 11, 2015.
(60) Provisional application No. 61/951,875, filed on Mar. 12, 2014.
(60) Provisional application No. 61/992,260, filed on May 13, 2014.

(51) Int. Cl. G07B 15/02

(52) U.S. Cl. CPC G07B 15/02

(57) ABSTRACT

A parking meter payment device is disclosed. In an example, the parking meter payment device is a modular parking meter payment device configured for installation in a parking meter. The example modular parking meter payment device includes a modular component, and a wireless communication device in the modular component. The wireless communication device is configured to receive a parking request from a mobile computing device at a parking meter. The example modular parking meter payment device also includes a transaction processing device in the modular component. The transaction processing device is configured to validate the parking request. The example modular parking meter payment device also includes an output device in the modular component. The output device is configured to indicate that the parking request is validated.

### CROSS REFERENCE TO RELATED APPLICATIONS

This application claims the priority benefit as a continuation-in-part (CIP) of U.S. patent application Ser. No. 14/645,196 filed Mar. 11, 2015 for “Parking Meter Payment Device” of Stanley J. Wolfson, which claims the priority benefit of U.S. Provisional Patent Application No. 61/951,875 filed Mar. 12, 2014 for “Digital Payment System” of Stanley J. Wolfson, and U.S. Provisional Patent Application No. 61/992,260 filed May 13, 2014 for “Digital Payment System” of Stanley J. Wolfson, each of which is hereby incorporated by reference in its entirety as though fully set forth herein.

### BACKGROUND

Purchases at parking meters have in the past required the user to have the exact change available for the transaction. However, these coin-operated parking meters were considered inconvenient in a cashless society. More recently, parking meters were enabled with credit card readers. However, credit card transactions are renowned for fraud, including the use of stolen credit cards, or credit card “skimmers” which can read credit card information from unaware users right at the credit card reader. As such, people are often hesitant to use credit cards for transactions where the risk of fraud is heightened.

### BRIEF DESCRIPTION OF THE DRAWINGS

FIG. 1 is a high-level illustration of an example networked system which may implement a parking meter payment device.

FIG. 2 is an illustration of example operations for a parking meter payment device.

FIG. 3 is an illustration of an example parking meter payment device.

FIG. 4 is a close up illustration of an example modular component of a payment device for a parking meter.

FIG. 6 is another close up illustration of the example modular component shown in FIG. 4 with an upper panel removed to show inside.

FIG. 6 is an illustration of an example circuit board or other circuitry which may be provided in the modular payment device shown in FIG. 5.

FIG. 7 is a process flow diagram illustrating example operations of a parking meter payment device.

### DETAILED DESCRIPTION

A parking meter payment device is disclosed herein which may be implemented to electronically pay for parking without needing to have a physical credit card or cash/coins or even a digital wallet on hand. As such, the parking meter payment device reduces the occurrence for fraud, while providing the user with convenience of a so-called “cashless” transaction.

An example parking meter payment device accepts payment via a digital payment system. A mobile computing device (e.g., mobile phone) may include an installed application or “app”. When the mobile computing device is activated via the app, it searches for any parking meter payment device(s) in the area. In an example, the app may display a list of such devices (e.g., parking meters in the user's vicinity) which accept payment via a digital payment system.

An example parking meter payment device includes a wireless communication device configured to receive a parking request from a mobile computing device. It is noted that the wireless communication device does not need to establish a connection to the payment provider or other entity. As such, the parking meter payment device does not need to be configured with an expensive to install and maintain modem or other communications system. The wireless communication device can instead be a BLUETOOTH™ or other near-field communications technology for communicating with the mobile computing device in proximity to the parking meter payment device.

An example parking meter payment device includes a transaction processing device to validate the parking request. In an example, the wireless communication device verifies payment by comparing the parking request from the mobile computing device with data stored in a local memory of the parking meter payment device. In an example, payment verification at the vendor device is according to the security protocol described in co-owned U.S. Provisional Patent Application No. 61/992,260 filed May 13, 2014 for “Digital Payment System” of Stanley J. Wolfson referenced above and incorporated herein by reference for all that it disclosed. Those details are not repeated again herein. Other example protocols for confirming payment information are also contemplated as being suitable for the purposes described herein.

In an example, the data used to validate the parking request may be stored in the local memory of the parking meter payment device and may include corresponding data, which when matched or otherwise connected with the parking request from the mobile device, ensures that the parking request from the mobile device is authorized and that the payment is already confirmed. The data is stored in the local memory of the parking meter payment device before a transaction is initiated. As such, no communication connection is required between the parking meter payment device and the payment system. This enables use of the parking meter payment device without having to provide expensive communication connections in each parking meter.

The example parking meter payment device is further configured to indicate parking time which has been paid for after confirming payment for parking e.g., that the parking request is valid). In an example, the parking meter displays a timer indicating parking duration after the wireless communication device verifies payment for the parking. In an example, only the original payee can purchase additional parking time without resetting the timer.

An operator of the parking meter (e.g., city or private parking facility) is paid by the third party payment processor without receiving payment information from an end-user. This arrangement enables the security of a cashless transaction (e.g., credit card or debit) while reducing the risk of fraud. For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the parking meter payment device (or anyone associated with the parking meter payment device). Likewise, the operator receives payment from a trusted third-party payment processor without risk that the payment form (e.g., credit card) is stolen or unauthorized.

The parking meter payment device may implement mobile payments without knowledge of credit card or other customer personal information. Validated payment transaction information is received to ensure payment has been confirmed. Payment to the operator may be processed immediately and/or on another basis (e.g., monthly payments) to enhance accounting (e.g., a monthly statement may be issued for all payments confirmed the prior month).

It is noted that the payment device disclosed herein is described as it may be implemented with a parking meter. However, those having ordinary skill in the art will be readily apprised of other applications after becoming familiar with the teachings herein. By way of illustration, other devices may include lock control (e.g., lock boxes), access control (e.g., gates, doors), transportation (e.g., bus, taxi, or train), admission (e.g., to a ball park or amusement park or museum or other attraction), vouchers, access control, car wash, donation box, vending machines, and any other pay-for-use and/or point of sale transactions.

Before continuing, it is noted that as used herein, the terms “includes” and “including” mean, but is not limited to, “includes” or “including” and “includes at least” or “including at least.” The term “based on” means “based on” and “based at least in part on.”

The term “parking request” and “payment confirmation” may include a “digital certificate” or “electronic information” or “data packet” or “token”. In an example, the parking request may be generated based on a payment confirmation. In another example, the parking request is the payment confirmation. These terms are intended to broadly designate data or information provided by the system to a mobile device, which may or may not be further processed by the mobile device, and which is capable of being processed in conjunction with data or information provided at the parking meter payment device to verify or otherwise confirm payment, e.g., as described in co-owned U.S. Provisional Patent Application No. 61/992,260 filed May 13, 2014 for “Digital Payment System” of Stanley J, Wolfson referenced above.

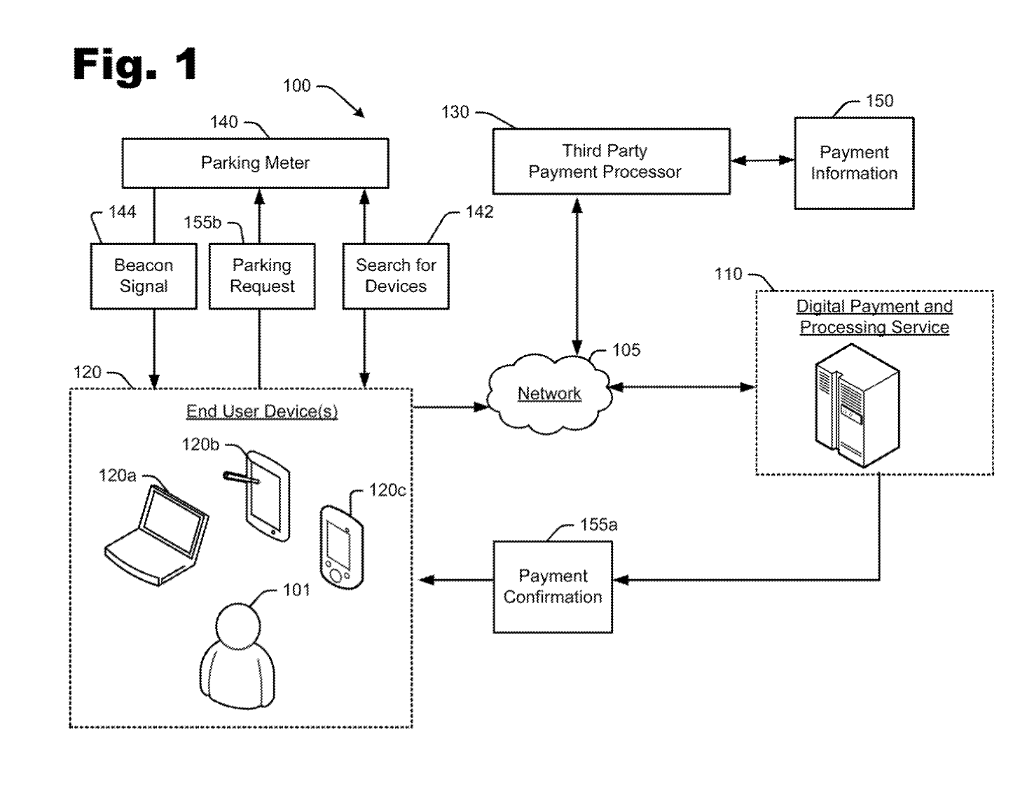

FIG. 1 is a high-level illustration of an example networked system which may implement a parking meter payment device 100. Digital payment and vending system 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other machine readable instructions described herein.

In an example, the digital payment and vending system 100 may be implemented by a host 110 providing a digital payment and vending service accessed by a user 101 via a client device 120. The client 120 may be any suitable computer or computing device 120a-c (e.g., laptop computer or other mobile device such as a phone or tablet) capable of accessing a third party payment processor 130. Of course, the host 110 and client 120 are not limited to any particular type of devices (e.g., watches and other wearable technology), and may also include other devices that are traditionally not considered to be a part of the mobile environment (e.g., desktop computing devices or terminals).

In an example, the digital payment and vending system 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the digital payment and vending system 100 provides a way for the user 101 to pay for parking at a parking meter 140, using the user's own mobile device 120, via the digital payment service, but without having to provide the parking meter 140 (or any other party associated with the parking meter 140) with access to payment information maintained by third party payment processor(s) 130 (e.g., a bank or credit card company).

In use, a mobile computing device (e.g., mobile phone) may include an installed application or “app”. When the mobile computing device is activated via the app, the mobile device 120 searches 142 for any parking meters 140 in the area which may be operated with the digital payment and vending system. In an example, the app may display a list of such device(s) 140 (e.g., parking meters in the user's vicinity) on the mobile device 120 which accept payment via the digital payment system.

The parking meter 140 may further include a beacon, wherein the beacon can enter into a two-way communication (illustrated in FIG. 1 as a beacon signal 144) with the mobile device 120 to present the user with a URL for more information about the parking meter payment device, where the get a coupon (e.g., a “targeted” coupon based on a user location, user profile, or other information), and/or present other information to the user. This information may be displayed for a user on a display device on the parking meter 140 and/or issues to the user's mobile device for display in the “app”.

An example parking meter 140 which is configured to operate with the digital payment system includes a wireless communication device configured to receive a parking request 155b from a mobile computing device. This parking request may be generated by the digital payment processing system and/or the app on the user's mobile device based on a payment confirmation 155a provided to the mobile device. That is, the payment confirmation 155a may be the parking request 155b, or the payment confirmation 155a may undergo at least some degree of processing at the mobile device 120 (e.g., by the app) to be transformed into the parking request 155b.

In an example, various operations of the digital payment and vending system 100 may be implemented at least in part by program code. Program code used to implement features of the system can be better understood with reference to the following discussion and corresponding figures of various example functions. The machine-readable instructions may be stored on a non-transient computer readable medium and are executable by one or more processor to perform the operations described herein. Examples of program code may include an end-user mobile device application (or “app”), payment processing application(s), host application (e.g., for generating a payment confirmation 155a in response to receiving confirmation of payment 150), and/or application at the parking meter 140 (e.g., for validating a parking request 155b from the end-user device 120). Of course, the operations described herein are not limited to any specific implementation with any particular type of program code.

It is noted, however, that the digital payment and vending system 100 is not strictly program code in the traditional sense. That is, the digital payment and vending system 100 may be implemented at least in part in program code (e.g., for generating a payment confirmation and for various of the transmission protocols). It is to be understood that the digital payment and vending system 100 is also implemented by device hardware which goes beyond a mere computing device provided to execute the program code. Example device hardware may include a wireless communication device with a communications interface (e.g., to the mobile device). Example device hardware may also include a vending device with associated electronic actuators, locks, motors, conveyors, timers, and/or other electronics operable to deliver goods and/or services in response to input from the wireless communication device and/or other processing device confirming payment for the goods and/or services. These and other aspects of the digital payment and vending system 100 will be described in more detail below such that the device hardware can be readily implemented by one having ordinary skill in the art after becoming familiar with the teachings herein.

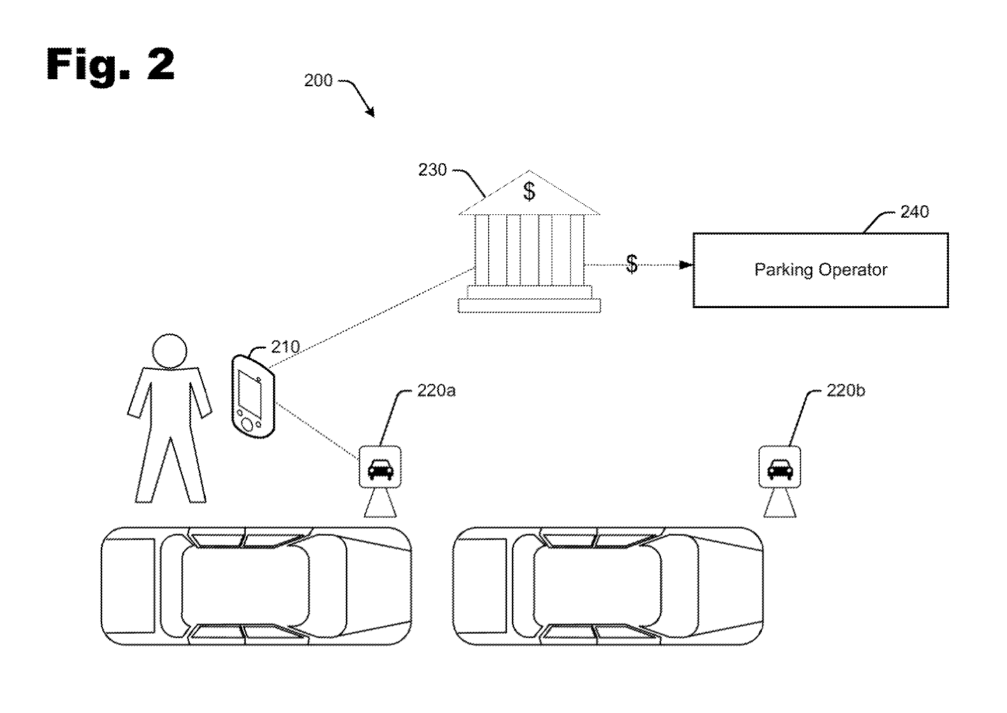

FIG. 2 is an illustration of an example parking meter with modular payment device. Many municipalities have embraced the idea of allowing parking space customers to make a payment without traditional coin operated systems. The system described herein further enhances the cashless transaction in that all transactions can be reported in remittance reports issued to the city government or other vendor. A separate set of accounting records are created every time a digital token or other electronic record is sent to the user and can be accessed by the vendor to verify payments to the city government or other vendor.

In this example, the user may use an app on his or her connected mobile device 210 to search for a “connected” parking meter. Alternatively, the user may manually search for a compatible parking meter (e.g., based on signage or prior knowledge of the location of a “connected” parking meter).

A location ID may be entered from the ID on the parking meter (e.g., 220a or 220b). The location ID may be entered manually by the user, or automatically (e.g., via BLUETOOTH™ connection or scanning a barcode or the like). A duration of parking time may also be selected or otherwise entered on the mobile device. The user selects a payment processor 230 to pay for the transaction and accept the charge to their account. After confirming payment, a parking request is generated and issued to the parking meter 220a indicating that the amount of time has been paid for and/or other data (e.g., the a parking meter ID or parking space at a parking facility).

The parking operator 240 may be paid immediately by the payment processor 230. at a later time (e.g., on a monthly basis). For example, some vendors may set up a debit account. Other vendors may charge the credit card on file immediately. Still others (such as cell phone companies) may add the charge to the customers' cell phone account.

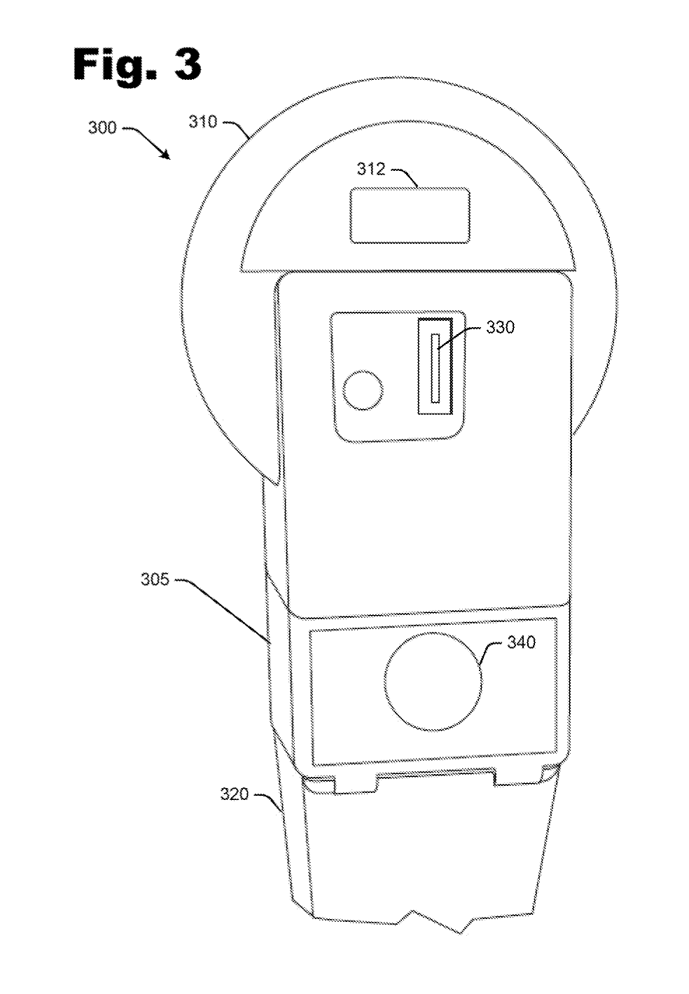

FIG. 3 is an illustration of an example parking meter payment device 300. In an example, the parking meter payment device 300 includes a modular component 305. The modular component 305 is configured to retrofit a traditional coin-operated parking meter 310. For example, the modular component 305 may be installed between a post (upper post portion 320 is shown) and a coin acceptor 330 on the coin-operated parking meter 310.

In an example, the modular component 305 may be configured to work with the display 350 to display parking time that has been paid for, or a message (e.g., PAID or EXPIRED). In another example, the modular component 305 may not interact with the display 312 and instead have its own display (e.g., on the side of modular component 305) or other indicator or display 340. Other displays and/or other output may be provided, e.g., for displaying advertising and/or other information for the user.

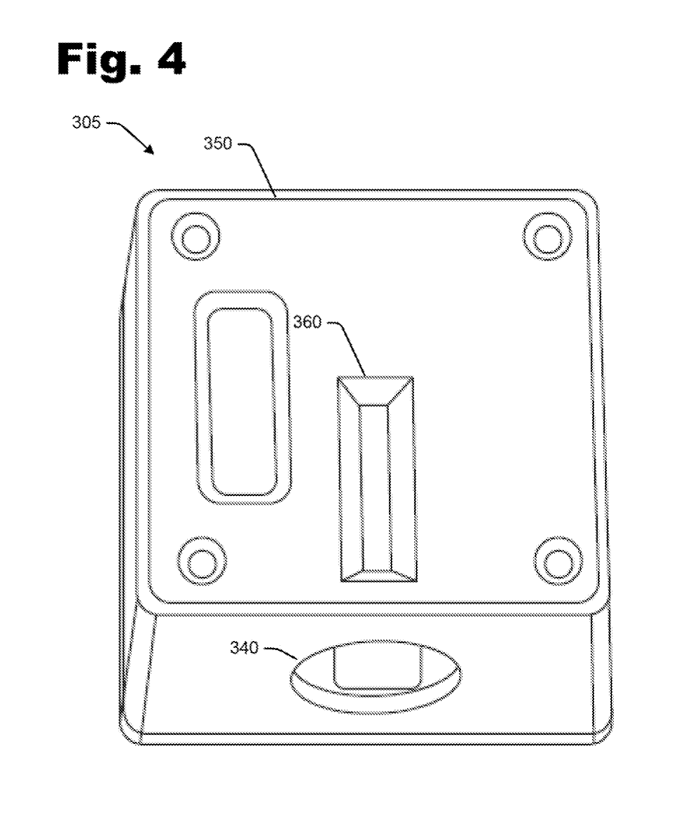

FIG. 4 is a close up illustration of an example modular component 305 of a payment device for a parking meter. FIG. 5 is another close up illustration of the modular component 305 shown in FIG. 4 with an upper panel or cover 350 removed to show inside of the modular component 305.

In an example, the modular component 305 has a pass-through 360 for coins (e.g., inserted into coin acceptor 330 shown in FIG. 3). The example modular component 305 includes a wireless communication device 370 configured to receive a parking request from a mobile computing device at the parking meter. The wireless communication device may be implemented as a BLUETOOTH™ or other near-field communication device.

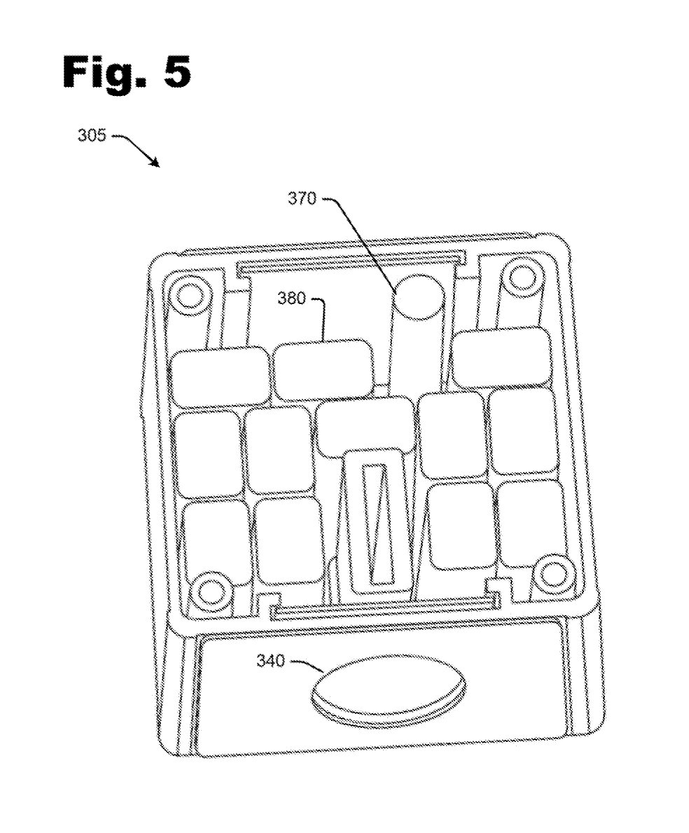

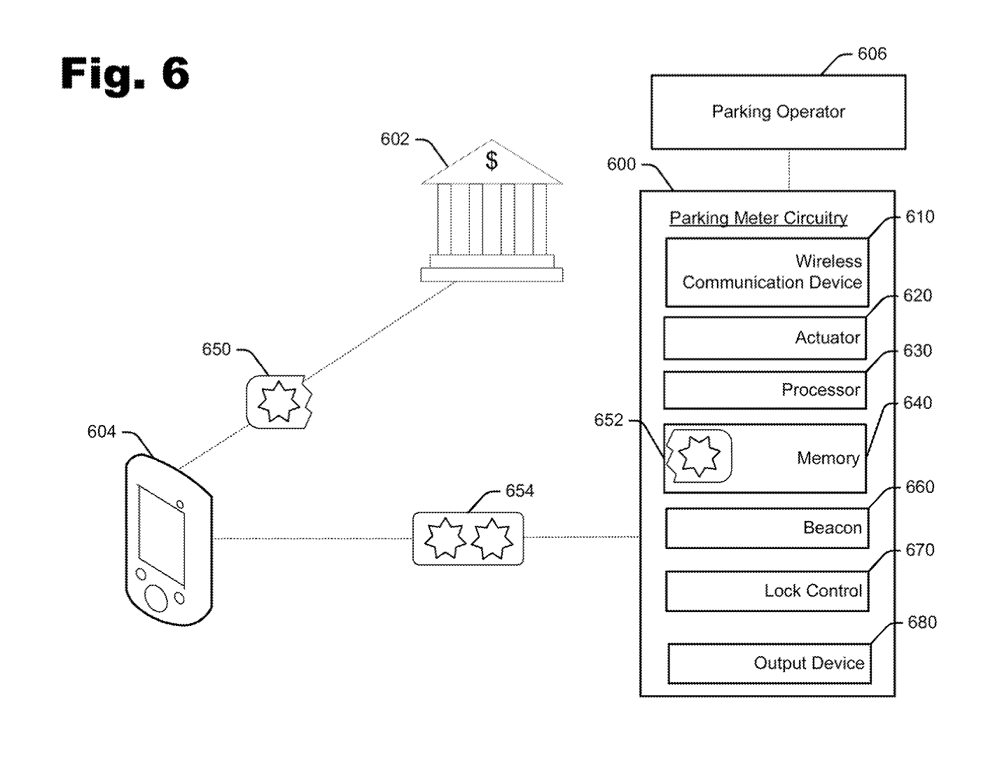

The example parking meter payment, device also includes a transaction processing device (not visible in FIG. 5; see FIG. 6 discussed below) to validate the parking request. The example parking meter payment device also includes an output device 340 to indicate that the parking request is validated, In an example, the output device 340 is a light or other display which may further identify the parking meter as belonging to a wireless payment system.

In an example, the modular component 305 has a battery power package (e.g., one or more batteries 380 shown in FIG. 5). The battery power package 380 may be replaceable by removing the upper portion or cover 350 to access the battery or batteries 380.

It should be noted that while a modular component 305 is shown as it may be used to retrofit existing parking meters, the parking meter payment device described herein is not limited to use with a modular component 305. Indeed, the parking meter payment device may be fully integrated into a parking meter with or without the traditional components of a coin acceptor and/or display and/or post.

FIG. 6 is an illustration of an example circuit board or other circuitry 600 which may be provided in the modular payment device 305 shown in FIG. 5. In an example, the parking meter circuitry 600 may be operable with a mobile device 604 and a parking operator 606 to confirm payment for the parking, e.g., via a third-party payment processor 602. The parking meter circuitry 600 may include a wireless communication device 610, an actuator 620, a processor 630, and a local memory 640.

The wireless communication device 610 is configured to receive a parking request from the mobile computing device 604. The processor 630 is configured to process the parking request 654 (e.g., by comparing the information in the parking request to information 652 in memory 640) and indicate parking time that has been paid for, e.g., by starting a time via actuator 6201.

In an example, a user of a mobile device 604 may desire to purchase parking time. The user may input a parking meter ID and any other information (e.g., parking time duration) into an app on the mobile device 604. Alternately, the user may scan a bar code or receive a wireless (e.g., BLUETOOTH™) signal from the parking meter circuitry 600 with this information.

In an example, the user may enter a current location for instance of particular vending device (e.g., a parking facility). Alternately a location may be obtained for a global positioning system (GPS) housed on the computing device in use. A choice of parking meters for that location may then be displayed for the user. In an example, the user may be prompted to use the last payment processor, or select an alternate payment processor (e.g., different credit card or bank account). The duration of time that the user wants to reserve in the parking area may be entered and payment information provided to the parking operator and the payment facilitator may approve payment.

In an example, the parking operator 606 is paid by the third party payment processor 602 without receiving any payment information from the end-user. This arrangement enables the security of a cashless transaction (e.g., credit card or debit) while reducing the risk of fraud. For example, the user may have already provided payment information (e.g., credit card or bank account information) to the third-party payment processor, who is a trusted payment processor such as the user's bank, credit card issuer, or other payment service, and therefore the user does not have to provide any payment information to the parking operator (or anyone associated with the parking operator). Likewise, the parking operator receives payment from a trusted third-party payment processor 602 without risk that the payment form (e.g., credit card) is stolen or unauthorized.

When the payment is approved, a parking request is generated. A record of the parking request may be kept by the parking facility operator and/or the payment facilitator.

The user may then confirm that he or she desires to complete the purchase. This information is processed and payment is confirmed by a third party payment service 602. The user of the mobile device may select the payment service 602, e.g., via the app on the mobile device 604. The payment processor processes payment to the vendor and deducts payment from the user's account. Example organization types that may serve as third-party payment facilitators may include, but are not limited to, mobile phone providers, parking facility operators, payment companies, credit card companies, and payment processor such as banks and credit card issuers.

After confirming payment, a payment confirmation 650 (or other like information indicating payment) may be issued to the mobile device 604. The mobile device may then issue a parking request 654 (the same payment confirmation or further processed data) to the parking meter. The parking meter circuitry 600 validates the parking request 654, e.g., by comparing data in the parking request 654 with data 652 in memory 640.

In an example, the data is stored in the local memory 640 of the parking meter circuitry 600 before a transaction is initiated. As such, no communication connection is required between the digital payment network and parking meter. The processor 630 may validate payment information from the mobile device (e.g., provided by the parking request). By way of illustration, payment verification at the vendor device is according to the security protocol described in co-owned U.S. Provisional Patent Application No. 61/992,260 filed May 13, 2014 for “Digital Payment System” of Stanley J. Wolfson referenced above and incorporated herein by reference for all that it disclosed.

Once payment is verified, the parking meter circuitry 600 may authorize the parking time which has been purchased by the user of the mobile device 604. For example, the processor 630 may be configured via the actuator 620 to start a timer to display the current parking time or message such as “PAID,” In an example, the parking request may be a one-time-use parking request with a fixed expiration so that the same parking request 650 is not being re-used.

The parking meter circuitry 600 may further include a beacon 660, wherein the beacon 660 can enter into a two-way communication with the mobile device 604 to present the user with a URL for more information about the parking meter payment device, where the get a coupon (e.g., a “targeted” coupon based on a user location, user profile, or other information), and/or present other information to the user.

The parking meter circuitry 600 may further include a lock control 670. The lock control 670 provides the ability to open at least one lock within the parking meter (e.g., for the vault area where coins or other money is stored, and/or the maintenance location such as where the battery pack is provided). Historically the parking meters have had issues with lost keys, stolen keys, and duplicated key for accessing the vault area, resulting in large amounts of pilfered money from the system. Most cities have only a few different key combinations to their vaults, other have a one meter one key system that requires and extensive key management system with multiple staff members. Through the use of the circuit board and actuator(s) disclosed herein, a maintenance person may make use of a cell phone or similar wireless communication device to open an internal lock within the parking meter. For example, the actuator may be operable with an electrically controlled lock, which secures the vault door in a closed position. The electrically controlled lock may be controlled by an app or other software on the mobile device which delivers a secure token to the circuit board to activate open the solenoid or other actuator.

In addition, the lock control 670 may be operated to open a maintenance area within the parking meter. For example, the power pack with its long lasting battery power can open the solenoid assisted locking system for many years. However, the battery pack may need replacing, and a similar lock actuator may be employed to open the parking meter for access to the batteries for replacement.

In an example, the lock control 670 may be programmed to operate specific locks during a set schedule. Once the schedule is past, it will no longer open locks. Schedules may include a date range, which can be set from one day to one year. As such, past employees cannot use the app to open the lock to retrieve money in the vault after their employment ends (e.g., to steal the money from the parking meter).

In an example, the locking device many also have a secondary override (e.g., a key which can be used if the electronic lock fails).

The parking meter circuitry 600 may further include an output device 680. The output device 680 may be a display (e.g., an LCD or LED display, a light ring, or other display). The output device 680 may be used to provide information to a user of the mobile device 604, to a parking meter attendant (e.g., to indicate payment and/or for enforcement), to potential customers (e.g., advertising), and/or others in the vicinity of the parking meter.

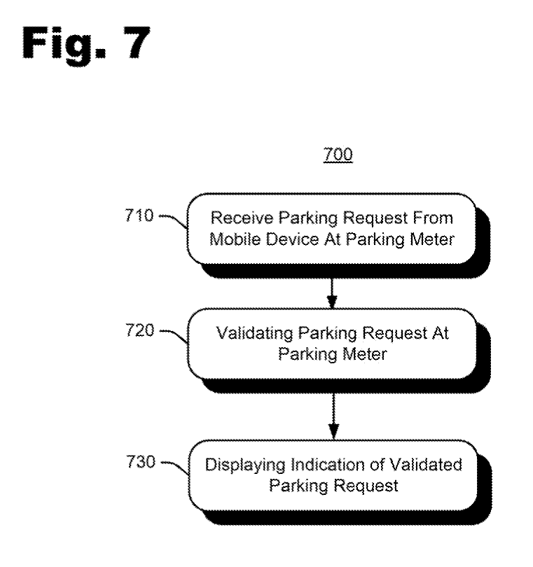

FIG. 7 is a process flow diagram illustrating example operations 700 of a parking meter payment device. Operation 710 includes receiving a parking request from a mobile computing device at a parking meter. Operation 720 includes validating the parking request at the parking meter. Operation 730 includes displaying an indication that the parking request is validated.

It is noted that the examples shown and described are provided for purposes of illustration and are not intended to be limiting. Still other examples are also contemplated.

1. A parking meter payment device, comprising:
a wireless communication device configured to receive a parking request from a mobile computing device at a parking meter, the parking request confirming payment by a third-party payment processor;
a transaction processing device to validate the parking request; and
an output device to indicate that the parking request is validated.

2. The parking meter payment device of claim 1, further comprising a modular component.

3. The parking meter payment device of claim 2, wherein the modular component is configured to retrofit a coin-operated parking meter.

4. The parking meter payment device of claim 3, wherein the modular component installs between a post and a coin acceptor on the coin-operated parking meter.

5. The parking meter payment device of claim 2, wherein the modular component has a pass-through for coins.

6. The parking meter payment device of claim 1, further comprising a battery power package.

7. The parking meter payment device of claim wherein the battery power package is replaceable by removing an upper portion to access the battery power package.

8. The parking meter payment device of claim 1, further comprising a beacon to communicate with the mobile computing device.

9. The parking meter payment device of claim t, further comprising at least one lock control for the parking meter.

10. The parking meter payment device of claim 1, wherein the wireless communication device includes a BLUETOOTH™ or other near-field communication device.

11. A modular parking meter payment device configured for installation in a parking meter, comprising:
a modular component;
a wireless communication device in the modular component, the wireless communication device configured to receive a parking request from a mobile computing device at a parking meter;
a transaction processing device in the modular component, the transaction processing device configured to validate the parking request; and
an output device in the modular component, the output device configured to indicate that the parking request is validated.

12. The modular parking meter payment device of claim 11, wherein the modular component is operable with a display to output a timer.

13. The modular parking meter payment device of claim 11, wherein the modular component is operable with a display to output a message.

14. The modular parking meter payment device of claim 11, wherein the output device displays a timer or message after verifying payment for parking time.

15. The modular parking meter payment device of claim 11, wherein only an original payee can purchase additional parking time without resetting the timer.

16. The modular parking meter payment device of claim 11, wherein the modular component is configured to retrofit a coin-operated parking meter.

17. The modular parking meter payment device of claim 11, wherein the modular component installs between a post and a coin acceptor on the coin-operated parking meter.

18. The modular parking meter payment device of claim 11, wherein the modular component has a pass-through for coins.

19. The modular parking meter payment device of claim 11, further comprising a battery power package.

20. A parking meter payment method, comprising:
receiving a parking request from a mobile computing device at a parking meter;
validating the parking request at the parking meter; and
displaying an indication that the parking request is validated.
